(19) United States
(12) Patent Application Publication
(10) Pub. No.: US 2026/0270692 A1
(43) Pub. Date: Sep. 10, 2026

(54) METHOD, APPARATUS AND COMPUTER PROGRAM

(71) Applicant: Nokia Technologies Oy, Espoo (FI)

(72) Inventors: Ranganathan MAVUREDDI DHANASEKARAN, Munich (DE); Rakshesh PRAVINCHANDRA BHATT, Bangalore (IN); Divya G NAIR, Bangalore (IN)

(21) Appl. No.: 19/166,617

(22) PCT Filed: Mar. 18, 2024
(86) PCT No.: PCT/IB2024/052603

§ 371 Date: Sep. 18, 2025

(30) Foreign Application Priority Data
Mar. 21, 2023 (GB) 2304122.1

(51) Int. Cl. H04W 12/041; H04W 12/106; H04W 84/06

(52) U.S. Cl. CPC H04W 12/041; H04W 12/106; H04W 84/06

(57) ABSTRACT

There is provided an apparatus comprising means for: receiving, from a satellite-based access node, a message comprising satellite access information; deriving a security key for satellite-based access based on the satellite access information; and performing a security procedure with the satellite-based access node based on the security key.

### FIELD

The present application relates to a method, apparatus, system and computer program and in particular but not exclusively to deriving a security key for satellite-based access to a wireless network.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite-based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Terrestrial Radio Access Network (UTRAN). Other examples of communication systems are the long-term evolution (LTE) of the Universal Mobile Telecommunications System (UMTS) radio-access technology and so-called 5^{th} generation (5G) or New Radio (NR) networks. NR is being standardized by the 3rd Generation Partnership Project (3GPP).

### SUMMARY

According to an aspect, there is provided an apparatus comprising means for: receiving, from a satellite-based access node, a message comprising satellite access information; deriving a security key for satellite-based access based on the satellite access information; and performing a security procedure with the satellite-based access node based on the security key.

Performing a security procedure may be further based on a security key available at the satellite-based access node.

Performing the security procedure may comprise sending an access stratum security mode complete message to the satellite-based access node based on the security key. The access stratum security mode complete message may be integrity protected, or encrypted, or integrity protected and encrypted based on the security key.

The satellite access information may comprise information indicating a user equipment access type as being satellite-based access, and wherein deriving the security key may be further based on the information indicating the user equipment access type as being satellite-based access.

The satellite access information may comprise information indicating a type of satellite, and wherein deriving the security key may be further based on the information indicating a type of satellite.

The type of satellite may be one of: low Earth orbit, medium Earth orbit, geostationary Earth orbit, or other satellite type.

The satellite access information may comprise information identifying a satellite, and wherein deriving the security key may be further based on the information identifying the satellite.

The satellite access information may comprise information indicating that the target access node type is non-terrestrial, and wherein deriving the security key may be further based on the information indicating that the target access node type is non-terrestrial.

Deriving the security key may be based on a next hop chaining count value, wherein the next hop chaining count value is an integer having a maximum value greater than 7.

According to an aspect, there is provided an apparatus comprising means for: receiving, from a satellite-based access node, a message comprising satellite access information; deriving a security key for satellite-based access based on the satellite access information, and sending, to the satellite-based access node, a response comprising the security key.

The satellite access information may comprise information indicating a user equipment access type as being satellite-based access, and wherein deriving the security key may be further based on the information indicating the user equipment access type as being satellite-based access.

The satellite access information may comprise information indicating a type of satellite, and wherein deriving the security key may be further based on the information indicating a type of satellite.

The type of satellite may be one of: low Earth orbit, medium Earth orbit, geostationary Earth orbit, or other satellite type.

The satellite access information may comprise information identifying a satellite, and wherein deriving the security key may be further based on the information identifying the satellite.

The satellite access information may comprise information indicating that the target access node type is non-terrestrial, and wherein deriving the security key may be further based on the information indicating that the target access node type is non-terrestrial.

Deriving the security key may be based on a next hop chaining count value, wherein the next hop chaining count value is an integer having a maximum value greater than 7.

According to an aspect, there is provided an apparatus comprising means for: sending, to an access and mobility management function, a message comprising satellite access information; receiving, from the access and mobility management function, a response comprising a security key for satellite-based access, wherein the security key is based at least in part on the satellite access information; sending, to a user equipment, a security message comprising the satellite access information; and performing a security procedure with the user equipment based on the security key received from the access and mobility management function.

Performing the security procedure with the user equipment may be further based on a security key generated by the user equipment based on the satellite access information.

Performing the security procedure may comprise receiving an access stratum security mode complete message from the user equipment based on the security key. The access stratum security mode complete message may be integrity protected, or encrypted, or integrity protected and encrypted based on the security key.

According to an aspect, there is provided an apparatus comprising at least one processor and at least one memory storing instructions that, when executed by the at least one processor, cause the apparatus at least to: receive, from a satellite-based access node, a message comprising satellite access information; derive a security key for satellite-based access based on the satellite access information; and perform a security procedure with the satellite-based access node based on the security key.

The at least one processor may further cause the apparatus to perform the security procedure further based on a security key available at the satellite-based access node.

The at least one processor may further cause the apparatus to send an access stratum security mode complete message to the satellite-based access node based on the security key. The access stratum security mode complete message may be integrity protected, or encrypted, or integrity protected and encrypted based on the security key.

The satellite access information may comprise information indicating a user equipment access type as being satellite-based access, and wherein the at least one processor may cause the apparatus to derive the security key based on the information indicating the user equipment access type as being satellite-based access.

The satellite access information may comprise information indicating a type of satellite, and wherein the at least one processor may cause the apparatus to derive the security key based on the information indicating a type of satellite.

The type of satellite may be one of: low Earth orbit, medium Earth orbit, geostationary Earth orbit, or other satellite type.

The satellite access information may comprise information identifying a satellite, and wherein the at least one processor may cause the apparatus to derive the security key based on the information identifying the satellite.

The satellite access information may comprise information indicating that the target access node type is non-terrestrial, and wherein the at least one processor may cause the apparatus to derive the security key based on the information indicating that the target access node type is non-terrestrial.

Deriving the security key may be based on a next hop chaining count value, wherein the next hop chaining count value is an integer having a maximum value greater than 7.

According to an aspect, there is provided an apparatus comprising at least one processor and at least one memory storing instructions that, when executed by the at least one processor, cause the apparatus at least to: receive, from a satellite-based access node, a message comprising satellite access information; derive a security key for satellite-based access based on the satellite access information, and send, to the satellite-based access node, a response comprising the security key.

The satellite access information may comprise information indicating a user equipment access type as being satellite-based access, and wherein the at least one processor may cause the apparatus to derive the security key based on the information indicating the user equipment access type as being satellite-based access.

The satellite access information may comprise information indicating a type of satellite, and wherein the at least one processor may cause the apparatus to derive the security key based on the information indicating a type of satellite.

The type of satellite may be one of: low Earth orbit, medium Earth orbit, geostationary Earth orbit, or other satellite type.

The satellite access information may comprise information identifying a satellite, and wherein the at least one processor may cause the apparatus to derive the security key based on the information identifying the satellite.

The satellite access information may comprise information indicating that the target access node type is non-terrestrial, and wherein the at least one processor may cause the apparatus to derive the security key based on the information indicating that the target access node type is non-terrestrial.

Deriving the security key may be based on a next hop chaining count value, wherein the next hop chaining count value is an integer having a maximum value greater than 7.

According to an aspect, there is provided an apparatus comprising at least one processor and at least one memory storing instructions that, when executed by the at least one processor, cause the apparatus at least to: send, to an access and mobility management function, a message comprising satellite access information; receive, from the access and mobility management function, a response comprising a security key for satellite-based access, wherein the security key is based at least in part on the satellite access information; send, to a user equipment, a security message comprising the satellite access information; and perform a security procedure with the user equipment based on the security key received from the access and mobility management function.

The at least one processor may further cause the apparatus to perform the security procedure with the user equipment further based on a security key generated by the user equipment based on the satellite access information.

The at least one processor may further cause the apparatus to receive an access stratum security mode complete message from the user equipment based on the security key. The access stratum security mode complete message may be integrity protected, or encrypted, or integrity protected and encrypted based on the security key.

According to an aspect, there is provided a method comprising: receiving, from a satellite-based access node, a message comprising satellite access information; deriving a security key for satellite-based access based on the satellite access information; and performing a security procedure with the satellite-based access node based on the security key.

Performing the security procedure with the satellite-based access node may be further based on a security key available at the satellite-based access node.

Performing the security procedure may comprise sending an access stratum security mode complete message to the satellite-based access node based on the security key. The access stratum security mode complete message may be integrity protected, or encrypted, or integrity protected and encrypted based on the security key.

The satellite access information may comprise information indicating a user equipment access type as being satellite-based access, and wherein deriving the security key may be further based on the information indicating the user equipment access type as being satellite-based access.

The satellite access information may comprise information indicating a type of satellite, and wherein deriving the security key may be further based on the information indicating a type of satellite.

The type of satellite may be one of: low Earth orbit, medium Earth orbit, geostationary Earth orbit, or other satellite type.

The satellite access information may comprise information identifying a satellite, and wherein deriving the security key may be further based on the information identifying the satellite.

The satellite access information may comprise information indicating that the target access node type is non-terrestrial, and wherein deriving the security key may be further based on the information indicating that the target access node type is non-terrestrial.

Deriving the security key may be based on a next hop chaining count value, wherein the next hop chaining count value is an integer having a maximum value greater than 7.

According to an aspect, there is provided a method comprising: receiving, from a satellite-based access node, a message comprising satellite access information; deriving a security key for satellite-based access based on the satellite access information, and sending, to the satellite-based access node, a response comprising the security key.

The satellite access information may comprise information indicating a user equipment access type as being satellite-based access, and wherein deriving the security key may be further based on the information indicating the user equipment access type as being satellite-based access.

The satellite access information may comprise information indicating a type of satellite, and wherein deriving the security key may be further based on the information indicating a type of satellite.

The type of satellite may be one of: low Earth orbit, medium Earth orbit, geostationary Earth orbit, or other satellite type.

The satellite access information may comprise information identifying a satellite, and wherein deriving the security key may be further based on the information identifying the satellite.

The satellite access information may comprise information indicating that the target access node type is non-terrestrial, and wherein deriving the security key may be further based on the information indicating that the target access node type is non-terrestrial.

Deriving the security key may be based on a next hop chaining count value, wherein the next hop chaining count value is an integer having a maximum value greater than 7.

According to an aspect, there is provided a method comprising: sending, to an access and mobility management function, a message comprising satellite access information; receiving, from the access and mobility management function, a response comprising a security key for satellite-based access, wherein the security key is based at least in part on the satellite access information; sending, to a user equipment, a security message comprising the satellite access information; and performing a security procedure with the user equipment based on the security key received from the access and mobility management function.

Performing the security procedure with the user equipment may be further based on a security key generated by the user equipment.

Performing the security procedure may comprise receiving an access stratum security mode complete message from the user equipment based on the security key. The access stratum security mode complete message may be integrity protected, or encrypted, or integrity protected and encrypted based on the security key.

According to an aspect, there is provided a computer readable medium comprising instructions which, when executed by an apparatus, cause the apparatus to perform at least the following: receiving, from a satellite-based access node, a message comprising satellite access information; deriving a security key for satellite-based access based on the satellite access information; and performing a security procedure with the satellite-based access node based on the security key.

The instructions, when executed by the apparatus, may further cause the apparatus to perform the security procedure with the satellite-based access node further based on a security key available at the satellite-based access node.

The instructions, when executed by the apparatus, may further cause the apparatus to perform sending an access stratum security mode complete message to the satellite-based access node based on the security key. The access stratum security mode complete message may be integrity protected, or encrypted, or integrity protected and encrypted based on the security key.

The satellite access information may comprise information indicating a user equipment access type as being satellite-based access, and wherein deriving the security key may be further based on the information indicating the user equipment access type as being satellite-based access.

The satellite access information may comprise information indicating a type of satellite, and wherein deriving the security key may be further based on the information indicating a type of satellite.

The type of satellite may be one of: low Earth orbit, medium Earth orbit, geostationary Earth orbit, or other satellite type.

The satellite access information may comprise information identifying a satellite, and wherein deriving the security key may be further based on the information identifying the satellite.

The satellite access information may comprise information indicating that the target access node type is non-terrestrial, and wherein deriving the security key may be further based on the information indicating that the target access node type is non-terrestrial.

Deriving the security key may be based on a next hop chaining count value, wherein the next hop chaining count value is an integer having a maximum value greater than 7.

According to an aspect, there is provided a computer readable medium comprising instructions which, when executed by an apparatus, cause the apparatus to perform at least the following: receiving, from a satellite-based access node, a message comprising satellite access information; deriving a security key for satellite-based access based on the satellite access information, and sending, to the satellite-based access node, a response comprising the security key.

The satellite access information may comprise information indicating a user equipment access type as being satellite-based access, and wherein deriving the security key may be further based on the information indicating the user equipment access type as being satellite-based access.

The satellite access information may comprise information indicating a type of satellite, and wherein deriving the security key may be further based on the information indicating a type of satellite.

The type of satellite may be one of: low Earth orbit, medium Earth orbit, geostationary Earth orbit, or other satellite type.

The satellite access information may comprise information identifying a satellite, and wherein deriving the security key may be further based on the information identifying the satellite.

The satellite access information may comprise information indicating that the target access node type is non-terrestrial, and wherein deriving the security key may be further based on the information indicating that the target access node type is non-terrestrial.

Deriving the security key may be based on a next hop chaining count value, wherein the next hop chaining count value is an integer having a maximum value greater than 7.

According to an aspect, there is provided a computer readable medium comprising instructions which, when executed by an apparatus, cause the apparatus to perform at least the following: sending, to an access and mobility management function, a message comprising satellite access information; receiving, from the access and mobility management function, a response comprising a security key for satellite-based access, wherein the security key is based at least in part on the satellite access information; sending, to a user equipment, a security message comprising the satellite access information; and performing a security procedure with the user equipment based on the security key received from the access and mobility management function.

The instructions, when executed by the apparatus, may further cause the apparatus to perform the security procedure with the user equipment further based on a security key generated by the user equipment.

The instructions, when executed by the apparatus, may further cause the apparatus to perform receiving an access stratum security mode complete message from the user equipment based on the security key. The access stratum security mode complete message may be integrity protected, or encrypted, or integrity protected and encrypted based on the security key.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIGS. 4-6 illustrate some multi-connectivity scenarios involving at least one non-terrestrial network-based access node;

FIGS. 7a-c show methods according to some examples;

FIG. 8 shows a signalling flow for satellite access based network registration for a user equipment according to some examples; and

FIG. 9 shows a key derivation scheme according to some examples.

### DETAILED DESCRIPTION

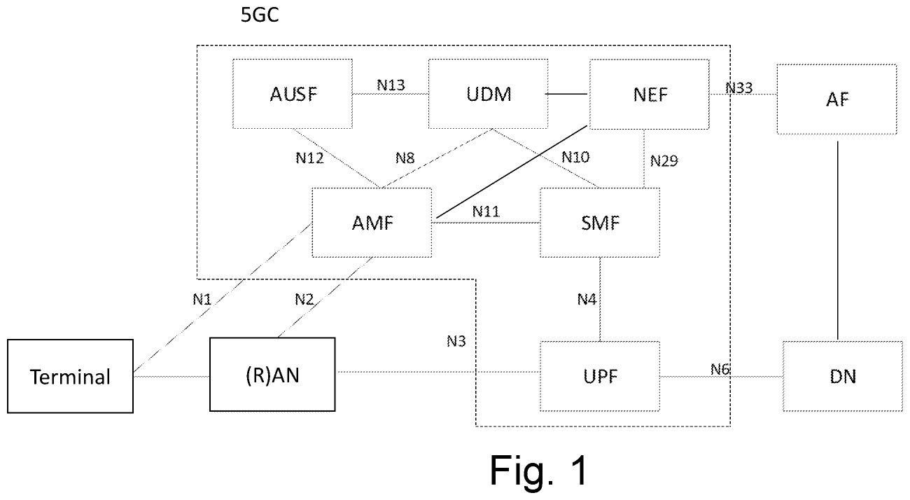

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (gNB) or one or more gNB distributed unit (DU) functions connected to one or more gNB centralized unit (CU) functions.

The 5GC may comprise the following entities: Network Slice Selection Function (NSSF); Network Exposure Function (NEF); Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

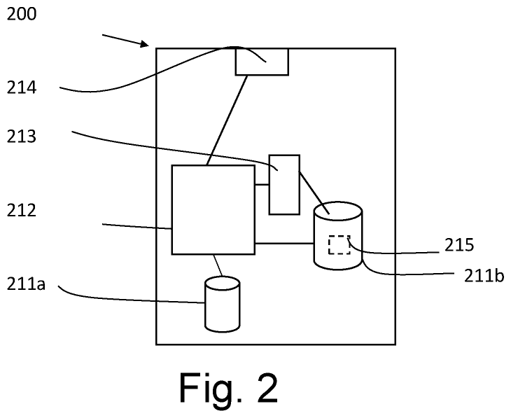

FIG. 2 illustrates an example of a control apparatus 200 for controlling a function of the 5GRAN or the 5GC as illustrated on FIG. 1. The control apparatus may comprise at least one random access memory (RAM) 211a, at least one read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

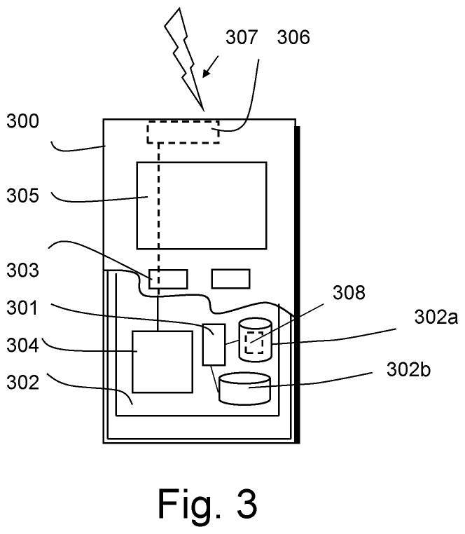

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

Advances in networking standards and deployments may allow for integration of non-terrestrial network (NTN) use cases alongside or in combination with terrestrial networks. Non-Terrestrial Networks may be defined as networks, or segments of networks, using an airborne or space-borne vehicle (herein referred to as a satellite) to embark a transmission equipment relay node or access node/base station. As used herein, an NTN-based access node (or satellite-based access node) is understood as being a satellite providing at least some of the functionality of an access node, such as a gNB.

One major benefit of NTNs is in their capability to offer wide area coverage by providing connectivity over the regions that may be expensive or difficult to cover with terrestrial networks (e.g., rural areas, vessels in oceans, airplanes). NTNs systems may enhance network coverage by offering wide-area coverage and ensuring service availability, continuity, and scalability, and may represent a coverage extension for the terrestrial network. NTN systems may therefore be an effective solution to complement terrestrial networks in providing services over uncovered or under-served geographical areas.

In the context of NTN, an NTN based access node may comprise a transparent or regenerative payload. A transparent payload may comprise operations such as Radio Frequency filtering, Frequency conversion and amplification, where a waveform signal repeated by the payload is un-changed. A regenerative payload may comprise operations such as Radio Frequency filtering, Frequency conversion and amplification as well as demodulation/decoding, switch and/or routing, coding/modulation. These regenerative payload operations may be similar to base station functions (e.g. gNB), but performed at or on board a satellite.

For a transparent satellite, the satellite, NTN gateway and gNB, all together, may be referred to as an access node (in some examples, more specifically a NG-RAN). In such cases, the satellite and NTN gateway may be referred to as a Remote radio unit. For a regenerative satellite, the gNB (which may be located in satellite itself) and the NTN gateway, together may be referred to as an access node (in some examples more specifically a NG-RAN).

In order to ensure reliable communications over NTN, where not only the UE but the access node (i.e. the satellite) also has mobility, it may be important to share UE location to the network, and satellite location to the UE. This may help ensure continuous communications between devices and the networks. Various different mechanisms may be used for sharing UE and satellite location. For example, some access nodes (e.g. NG-RAN) may support access node location reporting for services that require accurate cell identification (e.g. emergency services, lawful intercept, charging) or for UE mobility event notification service subscribed to an Access and Mobility management Function (AMF) by other NFs.

Access node location reporting may be used by the AMF when a target UE is in CM-CONNECTED state. Access node location reporting may be used by the AMF to determine a geographically located Tracking Area Identifier (TAI) in the case of satellite access. If the AMF requests UE location, in the case of satellite access, the access node may provide broadcast TAIs to the AMF as part of User Location Information (ULI). The access node may also report the TAI where the UE is geographically located if this TAI can be determined. The serving PLMN may enforce mobility restrictions for satellite access.

The AMF may verify the UE location (e.g. based on information indicating a selected PLMN ID and User location information allowed or not for satellite access). A moving radio cell for satellite access may indicate support for one or more tracking area codes (TACs) for each PLMN. A UE that is registered with a PLMN may access a radio cell and may not need to perform a Mobility Registration Update procedure as long as at least one supported TAC for the roaming PLMN (RPLMN) or equivalent to the RPLMN is part of the UE Registration Area.

A tracking area is Earth stationary, so an access node can change TAC if the cell moves (i.e. if the satellite providing the cell moves relative to the Earth), or the access node may assign more TAC (i.e. may dynamically add or remove TAC when cell moves).

User Location Information may be shared by the access node to AMF in different messages, such as Initial layer 3 UE message, packet data unit (PDU) session resource release/modify response/indication, Notify, UE context release complete or modification response, etc. User location information may comprise information such as E-UTRA/NR/Non-3GPP InterWorking Function (N3IWF)/Trusted Non-3GPP Gateway Function (TNGF)/Trusted WLAN Interworking Function (TWIF)/Wireline Access Gateway Function (W-AGF) user location info (for example as per clause 9.3.1.16 of TS 38.413).

In some examples, NTNs may be applied for dual access, where two access links are provided simultaneously. For example, at least one access link may be provided by a non-terrestrial network, and another access link may be provided by a terrestrial network or another NTN (i.e. a combination of terrestrial and non-terrestrial access or two different non-terrestrial access). This may provide benefits in a number of service scenarios, such as for users in residential homes in remote areas, users on board vehicles, high speed trains, vessels or airplanes.

For example, in underserved areas, the bandwidth provided by a terrestrial based access node (e.g. NR or LTE) may be limited at cell edge. Adding a further connection via an NTN based access node may enable targeted experience data rates to be achieved. In another example, for a mobile UE, such as on-board high-speed trains, the service area may not be fully homogeneous along the UE route and multi connectivity involving an NTN-based access node may enable to provide improved reliability.

An NTN-based access node may be geostationary orbit (GSO) or non-geostationary orbit, (NGSO) based. A UE may, in some examples, be connected and served simultaneously by:
One NTN-based access node and one terrestrial-based access node;
One NTN-based access node (e.g. NGSO) and another NTN-based access node (e.g. GSO);
One NTN-based access node (e.g. NGSO) via two different satellites of the same constellation.

The dual access can occur for either uplink or downlink or both. The same or different access node could serve cells via a terrestrial access network and via a satellite access network (e.g. with transparent payload on board the satellite). As used herein, an NTN based access node may refer to transparent payload satellites as well as regenerative payload satellites with, for example, some gNB functions on board.

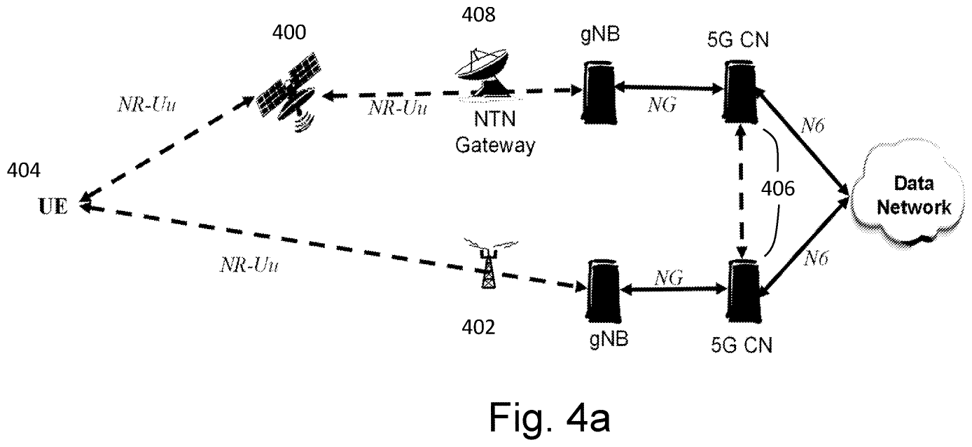

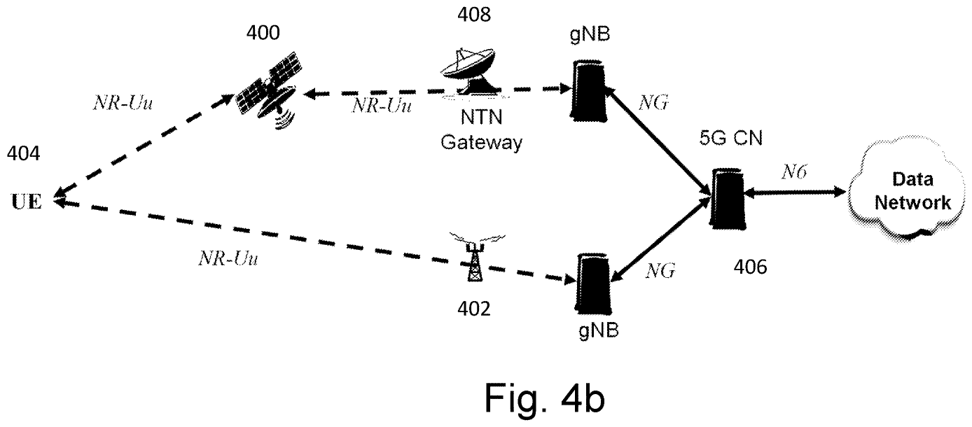

FIGS. 4-6 illustrate some multi-connectivity scenarios involving at least one NTN-based access node.

In FIG. 4, dual connectivity involving transparent payload NTN-based access node 400 and terrestrial access node 402 is shown. In the example of FIG. 4, a User Equipment 404 is connected to a 5G core network (5GC) 406 via simultaneously a transparent NTN-based access node and a cellular access node. The NTN Gateway 408 is located in the PLMN area of the cellular access network. FIG. 4a shows an example where both PLMNs are managed by different operators, and FIG. 4b shows an example where both PLMNs are managed by the same operator.

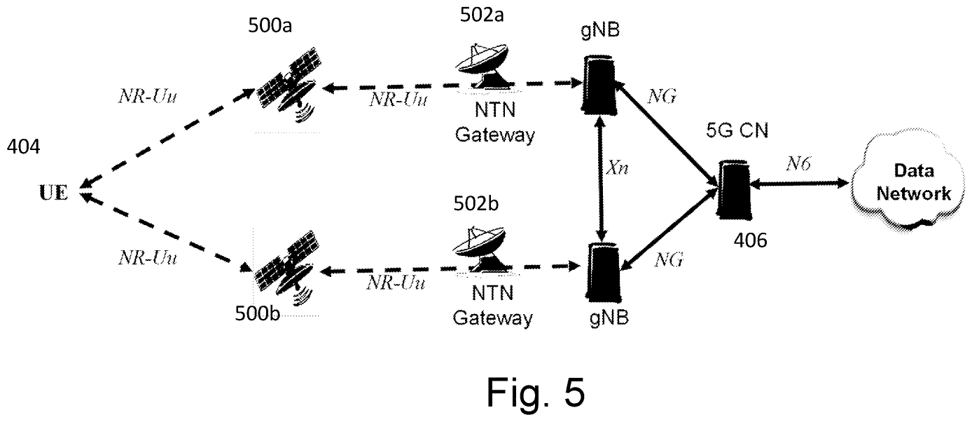

In FIG. 5, dual connectivity involving two transparent NTN-based access nodes 500a and 500b and corresponding NTN Gateways 502a and 502b is shown. The NTN-based access nodes may be GSO and/or NGSO based. A NGSO NTN-based access node may feature relatively low latency, and may be used to support delay sensitive traffic, while a GSO NTN-based access node may provide additional bandwidth to meet targeted throughput requirements.

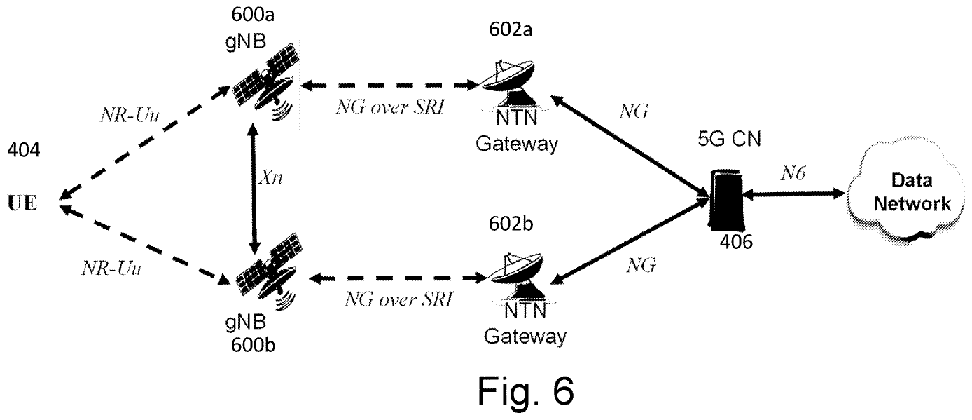

In FIG. 6, dual connectivity involving two regenerative NTN-based access nodes 600a and 600b (i.e. satellites with an access node such as a gNB on board) of a same constellation and corresponding NTN Gateways 602a and 602b with Inter Satellite Links in between is shown. In the example of FIG. 6, the NTN-based access nodes may communicate with the NTN gateway via satellite radio interface (SRI).

It should be understood that the examples shown in FIGS. 4-6 are for illustrative purposes only, and other architectures (e.g. split access node architecture between satellite and ground) and interfaces may be considered while remaining within the scope of the present disclosure.

In some examples, for the multi-connectivity to be enabled involving at least one NTN-based access node, there may be some coverage overlap between the access node access links involved. The UE may be in connected mode on at least one of the access links. A slice can be deployed and managed over both access links.

In case of same PLMN for both access links, the UE may be attached to the 5GC serving both access links. The 5GC may be aware of the respective characteristics of both access links.

In case of different PLMN for the respective access links, the UE may be subscribed to the home PLMN (HPLMN) and get access also to the other network through a roaming agreement. Information about the respective characteristics of the access links may be exchanged between both networks.

The UE may establish a service, such as voice over IP (VOIP), a video or a data service, over a first access link. The access link may be insufficient in Quality of Service (QoS) (e.g. throughput, latency, etc.). Given that a second access link is available, the second access link may be activated and combined with the first one to support the required QoS of the service.

According to the targeted QoS of the service, the user plane traffic of the connectivity can be dynamically steered, split and switched in both Uplink (UL) and Downlink (DL) directions between both access links taking into account the specific performances of each access link, for example, in terms of latency, throughput, Jitter, Error rate etc.

The QoS requirements of the user plane traffic can be determined through specific policies associated to different data flows, or different traffic type within the same data flow. Based on the QoS requirements (e.g. latency, throughput, Jitter, Error rate etc.), traffic characteristics, radio links conditions and UE's moving speed, the traffic may be steered/split across the access links. For example low latency requirement traffic may be split/steered to the access link featuring the lowest latency characteristics.

In case of hand-over, temporary radio link failure or congestion on one access link, the user plane traffic may be switched to the remaining active access link. When the radio link is re-established, the user plane may be split/steered across both access links based on QoS. The reported data volumes and other traffic statistics, on each access link, may be used for billing purposes.

Thanks to appropriate steering, splitting and switching of the user plane traffic, the dual access connectivity involving at least one NTN-based access node can support the targeted QoS that a single access may not support.

To enable some NTN-based access node operations, such as those described above, the 5G system may be required to support UE's simultaneous data transmission pertaining to the same data session across two access networks (using at least one satellite-based access node), and dynamically distribute user traffic between the two access networks, taking into account connectivity conditions on both access networks (e.g. radio characteristics, mobility, congestion) and UE's moving speed. The 5G system may also be required to collect charging information, for both links, simultaneously.

While the use of NTN-based access nodes may provide many benefits, there may be some problems and/or limitations associated with their use.

For example, it may be beneficial to be able to distinguish between terrestrial and non-terrestrial networks serving a UE. Furthermore, different satellites (LEO/MEO/GEO/Others) may have different beam foot-print sizes, different altitudes, and orbits, all of which may affect mobility aspects of the different access nodes. As such, the AMF may benefit from being able to distinguish between different satellite types (such as but not limited to: low Earth orbit (LEO), medium Earth orbit (MEO), geostationary Earth orbit (GEO or GSO) etc.) when defining a satellite access type.

When the UE is using a satellite-based access node, an indication may need to be provided in N2 interface indicating the type of satellite access. For satellite access, for the same UE, the serving access node may be moving, and thus the serving access node may keep changing. This may require changes in existing key derivation and hierarchies to allow specific methods to be used in NTN.

However, according to 3GPP Rel-19, dual access may be maintained with no differentiation between NTN and Terrestrial networks. When dual access is maintained by same AMF, for the same UE, there may be no differentiation factor for different access nodes during Radio Resource Control (RRC) and User Plane (UP) key generation.

Some examples may address one or more of these issues.

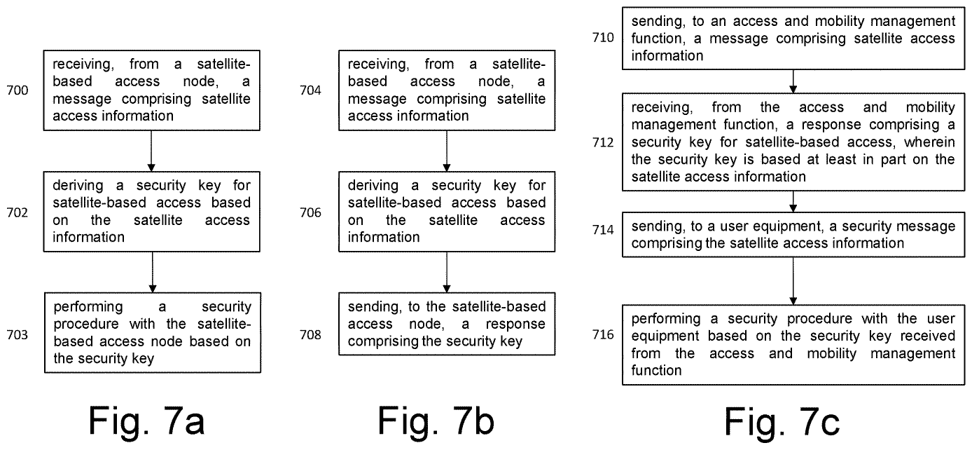

Reference is made to FIGS. 7a-c, which shows methods according to some examples. Steps 700-702 shown in FIG. 7a may in some examples be performed by a UE. Steps 704-708 shown in FIG. 7b may in some examples be performed by an AMF. Steps 710-714 shown in FIG. 7c may in some examples be performed by a satellite-based access node.

At 700, a method comprises receiving, from a satellite-based access node, a message comprising satellite access information.

At 702, the method comprises deriving a security key for satellite-based access based on the satellite access information.

At 703, the method comprises performing a security procedure with the satellite-based access node based on the security key. For example, the security procedure comprises sending a Access Stratum (AS) security mode complete message to the satellite-based access node based on the security key. The AS security mode complete message is protected based on the security key. The protection of the AS security complete message may be integrity protected, or encrypted, or integrity protected and encrypted.

At 704, a method comprises receiving, from a satellite-based access node, a message comprising satellite access information.

At 706, the method comprises deriving a security key for satellite-based access based on the satellite access information.

At 708, the method comprises sending, to the satellite-based access node, a response comprising the security key.

At 710, a method comprises sending, to an access and mobility management function, a message comprising satellite access information.

At 712, the method comprises receiving, from the access and mobility management function, a response comprising a security key for satellite-based access, wherein the security key is based at least in part on the satellite access information.

At 714, the method comprises sending, to a user equipment, a security message comprising the satellite access information. The security message may be a AS security mode command message.

At 716, the method comprises performing a security procedure with the user equipment based on the security key received from the access and mobility management function. Performing the security procedure comprises receiving an AS security mode complete message, wherein the AS security mode complete message is protected based on the security key. The protection of the AS security complete message may be integrity protected, or encrypted, or integrity protected and encrypted.

Some examples may relate to generating ciphering and integrity protection keys for satellite access nodes. Some examples may define specific access types and use this definition for generating and deriving keys for satellite access nodes.

Some examples may communicate the access type to the AMF. For example, during initial UE context establishment, satellite access type information can be communicated from satellite access node to AMF. This access type may be used for key generations and derivations.

Some examples may provide horizontal and vertical key derivation mechanisms for satellite access nodes to establish a security context. To support these key derivations, Next Hop (NH) and Next Hop Chaining Counter (NCC) may be used, as defined in 3GPP TS 33.501. In some examples, when there is no unused pair of {NH, NCC}, a horizontal key derivation procedure may be used, and when there is an unused pair of {NH, NCC}, a vertical key derivation procedure may be used.

The {NH,NCC} pair based key derivations may be used to perform seamless handover procedures. For satellite access, the procedures to determine {NH, NCC} pairs may be extended in order to take care of access node mobility as well.

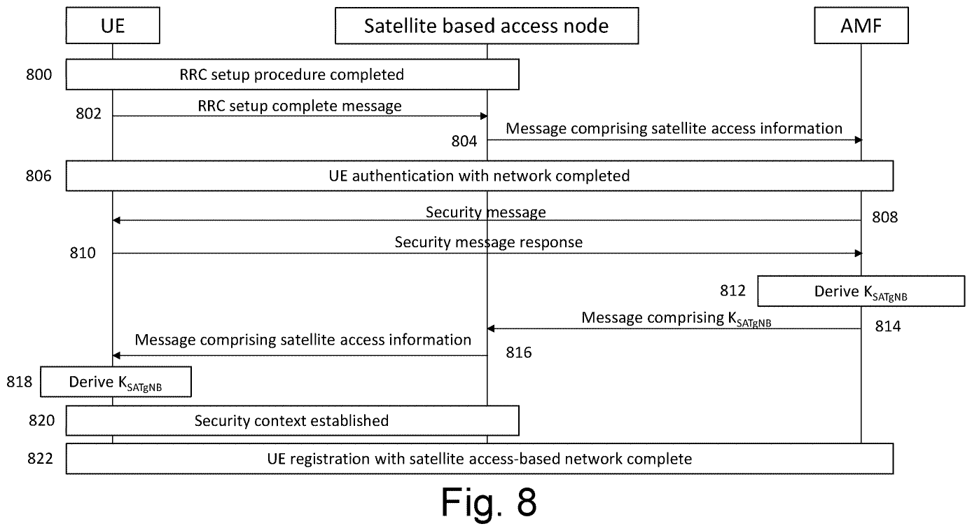

Reference is made to FIG. 8, which shows a signalling flow for Satellite Access based network registration for a UE according to some examples.

At 800, the UE and satellite-based access node complete an RRC setup procedure to establish an RRC connection between the UE and the satellite-based access node.

At 802, the UE sends an RRC setup complete message and non-access stratum (NAS) registration request to the satellite-based access node.

At 804, in response to receiving the RRC setup complete message and the NAS registration request, the satellite-based access node sends an initial UE message to the AMF. The initial UE message sent to the AMF may comprise satellite access information. The initial UE message may further comprise User location information of the UE. The message sent to the AMF may for example comprise an NGAP_INITITAL_UE_MESSAGE.

At 806, UE authentication with the network is completed. As part of this procedure, an AMF key KAMF is generated.

At 808, the AMF sends, to the UE, a security message, such as an NAS security mode command. In response, at 810 the UE sends a security message response, such as an NAS security mode complete message.

At 812, the AMF derives a satellite-based access node key K_{SATgNB}. The satellite-based access node key may be derived based on the AMF key and the satellite access information.

At 814, the AMF sends a message to the satellite-based access node. The message sent to the satellite-based access node may comprise the satellite-based access node key generated by the AMF at 812. The message sent to the satellite-based access node may for example comprise an NGAP_INITIAL_CONTEXT_SETUP message.

At 816, the satellite-based access node sends, to the UE, a security message, such as an AS security mode command. The security message may comprise the satellite access information.

At 818, the UE use the information received at 816 to locally generate a satellite-based access node key for satellite access.

Thus, after step 818, the satellite-based access node may have a key (K_{SATgNB}) which is derived by the AMF based on satellite access information and sent to the satellite-based access node; and the UE may have a key (K_{SATgNB}) derived by the UE based on satellite access information sent to the UE from the satellite-based access node, where the key at the satellite-based access node and the key at the UE match.

At 820, a security context is established between the UE and the satellite-based access node based on the keys generated at 812 and 816.

At 822, having established the security context at 818, UE registration with satellite access based network is completed.

In some examples, keys specific to satellite and terrestrial networks may be generated separately. A similar set of keys to satellite and terrestrial access node may be used, but the access types used in key generation are different. Due to the possibility of more frequent handover events (for example because of the satellite moving and UE moving), existing NCC and NH values may need to be adapted for the satellite keys. In some examples, the NCC value may be extended. In some examples, NH key derivation at AMF may consider the target access node type as NTN or terrestrial.

As mentioned above, in some examples, the initial UE message sent by the access node at 804 may comprise satellite access information. The satellite access information may comprise information indicating a type of access as being satellite access type. Table 1 below shows examples of one or more of the elements that may be included in the initial UE message:

TABLE 1
example information elements included in initial UE message

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | 9.3.1.1 | | YES | ignore |
| Type | | | | | |
| RAN UE | M | 9.3.3.2 | | YES | reject |
| NGAP ID | | | | | |
| NAS-PDU | M | 9.3.3.4 | | YES | reject |
| User Location | M | 9.3.1.16 | | YES | reject |
| Information | | | | | |
| RRC | M | 9.3.1.111 | | YES | ignore |
| Establishment | | | | | |
| Cause | | | | | |
| 5G-S-TMSI | O | 9.3.3.20 | | YES | reject |
| AMF Set ID | O | 9.3.3.12 | | YES | ignore |
| UE Context | O | ENUMERATED | | YES | ignore |
| Request | | (requested, | | | |
| | | . . . ) | | | |
| Allowed | O | 9.3.1.31 | | YES | reject |
| NSSAI | | | | | |
| Source to | O | 9.3.3.27 | | YES | ignore |
| Target AMF | | | | | |
| Information | | | | | |
| Reroute | | | | | |
| Selected | O | PLMN | Indicates | YES | ignore |
| PLMN | | Identity 9.3.3.5 | the selected | | |
| Identity | | | PLMN id | | |
| | | | for the non- | | |
| | | | 3GPP | | |
| | | | access. | | |
| IAB Node | O | ENUMERATED | Indication | YES | reject |
| Indication | | (true, . . . ) | of an IAB | | |
| | | | node | | |
| CE-mode-B | O | 9.3.1.156 | | YES | reject |
| Support | | | | | |
| Indicator | | | | | |
| LTE-M | O | 9.3.1.157 | | YES | ignore |
| Indication | | | | | |
| EDT Session | O | ENUMERATED | | YES | ignore |
| | | (true, . . . ) | | | |
| Authenticated | O | ENUMERATED | Indicates | YES | ignore |
| Indication | | (true, . . . ) | the FN-RG | | |
| | | | has been | | |
| | | | authenticated | | |
| | | | by the | | |
| | | | access | | |
| | | | network. | | |
| NPN Access | O | 9.3.3.46 | | YES | Reject |
| Information | | | | | |
| Satellite | O | x.y.z. . . . | Provides | YES | ignore |
| Access | | | information | | |
| information | | | about | | |
| | | | satellite | | |
| | | | access type | | |

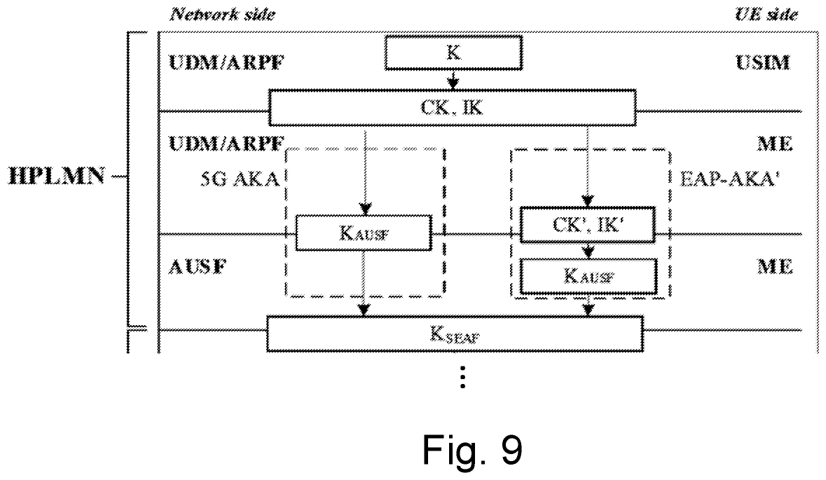

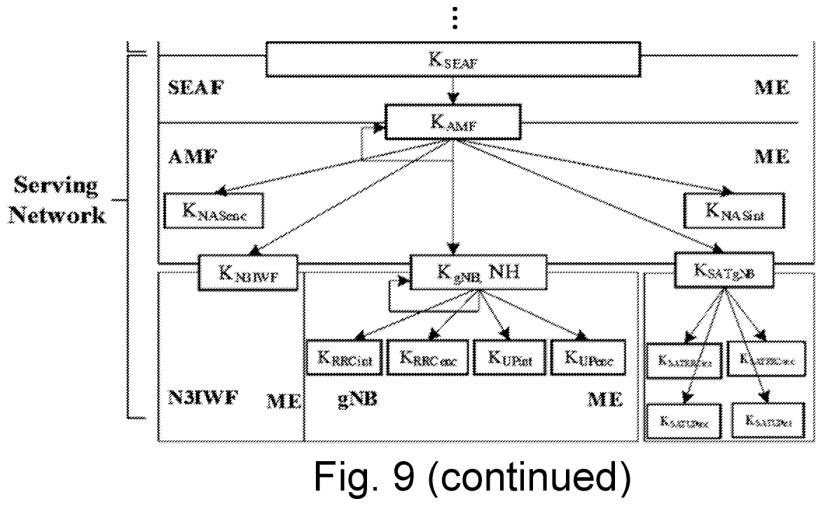

FIG. 9 shows an example where the satellite-based access node key K_{SATgNB}, may be derived based on the AMF key KAMF. The satellite-based access node key K_{SATgNB} may be used to derive further keys, such as K_{SATRRCint}, K_{SATRRCenc}, K_{SATUPenc} and K_{SATUPint} as shown in FIG. 9.

In some examples, the satellite-based access node key (and in some examples other keys such as K_{gNB}, K_{WAGF}, K_{INGF}, K_{TWIF} and K_{N3IWF}) may be derived based on KAMF and the uplink NAS COUNT in the UE and the AMF.

In some examples, the satellite-based access node key may be derived by the AMF at 812 and the UE at 818. The AMF and UE may derive the satellite-based access node key using one or more inputs to a key derivation function. The one or more inputs may comprise information included in the satellite access information sent by the satellite-based access node to the AMF in step 804 and UE in step 816. The one or more inputs may further comprise the AMF key. The AMF key KAMF may be a 256 bit key.

The satellite access information may comprise an access type distinguisher and/or a sub access type distinguisher. The access type distinguisher may comprise information indicating an access type as being 3GPP access, non 3GPP access, or satellite access. The sub access type distinguisher may comprise information indicating a type of satellite when the access type is satellite access. The type of satellite may be a GEO, MEO, LEO, or other satellite type.

In some examples, further information may be used when deriving the key. For example, the following parameters may be used to form the input S to the key derivation function:

$$FC = 0 \times 6 E$$

$$P 0 = Uplink NAS COUNT$$

$$L 0 = length of uplink NAS COUNT ( e . g . 0 \times 00 \; 0 \times 04 )$$

$$P 1 = Access type distinguisher$$

$$L 1 = length of Access type distinguisher ( e . g . 0 \times 00 \; 0 \times 01 )$$

$$P 2 = Sub access type distinguisher$$

$$L 2 = length of Sub access type distinguisher ( e . g . 0 \times 00 \; 0 \times 01 )$$

P2 and L2 may be sub access types which are valid for Satellite access type.

The access type distinguisher may have different values for the different access type. For example, the access type distinguisher may have a first value for 3GPP access, a second value for non-3GPP access, and a third value for satellite access.

Some example values for the access type distinguisher are provided in Table 2 below. The values 0x00 and 0x03 to 0xf0 may be reserved for future use, and the values 0xf1 to 0xff may be reserved for private use.

TABLE 2
example access type distinguisher values

| Access type distinguisher | Value |
|---|---|
| 3GPP access | 0x01 |
| Non 3GPP access | 0x02 |
| Satellite access | 0x03 |

The access type distinguisher P1 may be set to the value for 3GPP (e.g. 0x01) when deriving K_{gNB}. The access type distinguisher may be set to the value for non-3GPP (e.g. 0x02) when deriving K_{N3IWF}, K_{WAGF}, K_{TWIF} or K_{INGF}. The access type distinguisher may be set to the value for satellite access (e.g. 0x03) when deriving KgNB/KSATgNB.

The sub access type distinguisher may have different values for different satellite types. For example, the sub access type distinguisher may have a first value for GEO satellite, a second value for MEO satellite, a third value for LEO satellite, and a fourth value for other satellite types.

Some example values for the sub access type distinguisher are provided in Table 3 below. The sub access type distinguisher may be set to the value for GEO satellite (e.g. 0x01) when deriving KSATgNB for GEO satellite RAN. The Sub access type distinguisher may be set to the value for MEO satellite (e.g. 0x02) when deriving KSATgNB for MEO satellite RAN. The sub access type distinguisher may be set to the value for LEO satellite (e.g. 0x03) when deriving KSATgNB for LEO satellite RAN. The sub access type distinguisher may be set to the value for Other satellite (e.g. 0x04) when deriving KSATgNB for other satellite RAN.

TABLE 3
example sub access type distinguisher values

| Sub Access type distinguisher | Value |
|---|---|
| GEO satellite | 0x01 |
| MEO satellite | 0x02 |
| LEO satellite | 0x03 |
| OTHERSAT satellite | 0x04 |

This key derivation function may be applied when cryptographically protected 5G radio bearers are established and when a key change on-the-fly is performed. In some examples, when a UE is already registered in one access node (terrestrial) with a first AMF and later the UE tries to register using satellite-based access node with the first AMF, then the UE may not need to perform a new authentication. The first AMF may generate new set of keys for satellite-based access using the previously described access type differentiator.

In some examples, the satellite access information used to derive the satellite-based access node key may comprise information identifying a satellite.

In some examples, further information may be used when deriving the key. For example, the following parameters may be used to form the input S to the key derivation function:

$$FC = 0 \times 6 E$$

$$P 0 = Uplink NAS COUNT$$

$$L 0 = length of uplink NAS COUNT ( i . e . 0 \times 00 \; 0 \times 04 )$$

$$P 1 = Satellite ID$$

$$L 1 = length of Satellite ID ( i . e . 0 \times 00 \; 0 \times 04 )$$

In some examples, the input S may further comprise the AMF key. The AMF key KAMF may be a 256 bit key.

In some examples, a modified access node key K_{gNB} may be used instead of a dedicated satellite-based access node key K_{SATgNB}. The modified access node key K_{gNB} may be derived based on the AMF key.

The satellite access information may be used to derive the modified access node key K_{gNB}. The satellite access information may comprise information identifying an access node (e.g. gNB ID), an access identifier, or information identifying a satellite (e.g. satellite ID).

In some examples, further information may be used when deriving the key. For example, the following parameters may be used to form the input S to the key derivation function:

$$FC = 0 \times 6 E$$

$$P 0 = Uplink NAS COUNT$$

$$L 0 = length of uplink NAS COUNT ( i . e . 0 \times 00 \; 0 \times 04 )$$

$$P 1 = Access type distinguisher$$

$$L 1 = length of Access type distinguisher ( i . e . 0 \times 00 \; 0 \times 01 )$$

$$P 2 = gNB ID or access ID or Satellite ID$$

$$L 2 = length of gNB ID or access ID or Satellite ID ( i . e . 0 \times 00 \; 0 \times 01 )$$

In some examples, the input S may further comprise the AMF key. The AMF key KAMF may be a 256 bit key.

In some examples, the Access ID may be used to differentiate UE connected to two access points (same access type). For example, the AMF may provision UE and gNB in NAS security context with values 7 (access #1) and 8 (access #2) for two 3GPP access or two non-3GPP access or two NTN access. In some examples, when gNB or Satellite ID is used, then the AMF may provide the gNB or satellite ID to the access node and UE.

In some examples, the NH value may be used for mobility purposes. In case of vertical key derivations, the keys for a satellite-based access node may be derived from the NH parameters.

In some examples, the NH value may be derived based on the AMF key KAMF. In some examples the NH value may be derived based on the information included in the satellite access information. The satellite access information may comprise information indicating a type of target access node. The type of target access node may be a terrestrial access node or satellite-based access node. The AMF may send the NCC and NH pair to current serving satellite-based access node.

When deriving a NH from KAMF the following parameters may be used to form the input S to the KDF:

$$FC = 0 \times 6 F$$

$$P 0 = SYNC - input$$

$$L 0 = length of SYNC - input ( i . e . 0 \times 00 \; 0 \times 20 )$$

$$P 1 = target gNB type ( Terrestrial gNB : 0 \times 01 or NTN gNB : 0 \times 02 )$$

$$L 1 = length of target gNB type ( i . e . 0 \times 00 \; 0 \times 20 )$$

In some examples, the input S may further comprise the AMF key. The AMF key KAMF may be a 256 bit key.

The SYNC-input parameter P0 may be based on K_{gNB} for the initial NH derivation, and the previous NH for all subsequent derivations. This may result in a NH chain, where the next NH is always fresh and derived from the previous NH.

As mentioned previously, the satellite-based access node could be moving quite often. As such, there may be the possibility of more frequent cell change either due to UE mobility or satellite movement. As such, in some examples the NCC value may be increased from current value of 7, i.e. the NCC value may be an integer greater than 7, for example 15. The current maximum NCC value may be represented by 3 bits, while a maximum NCC value greater than 7 (e.g. 15) may be represented by more than 3 bits, e.g. 4 bits. The vertical key derivation may accommodate the NTN and terrestrial use cases.

In some examples the IE NextHopChainingCount may be used to update the K_{gNB} key and corresponds to parameter NCC. As the NCC value may range from 0 to a maximum value (e.g. 15), the NextHopChainingCount IE may for example be defined as:

| -- ASN1START | |
|---|---|
| -- TAG-NEXTHOPCHAININGCOUNT-START | |
| NextHopChainingCount ::= | INTEGER (0..15) |

-- TAG-NEXTHOPCHAININGCOUNT-STOP
-- ASN1STOP

Some examples may therefore relate to the derivation of keys for use in establishing secure connection between the UE and core network when utilizing a satellite-based access node. Some examples may repurpose the existing access node key K_{gNB}, while other examples may provide a new satellite-based access node key K_{SATgNB}. While some examples have been described with respect to aspects of a 5G network, it should be understood that in other examples may apply to other networks—for example 6G networks.

In some examples, the abovementioned procedures may be implemented by one or more apparatuses.

For example, an apparatus may comprise means for: receiving, from a satellite-based access node, a message comprising satellite access information; and deriving a security key for satellite-based access based on the satellite access information.

The apparatus may comprise at least one processor and at least one memory storing instructions that, when executed by the at least one processor, cause the apparatus at least to: receive, from a satellite-based access node, a message comprising satellite access information; and derive a security key for satellite-based access based on the satellite access information.

An apparatus may comprise means for: receiving, from a satellite-based access node, a message comprising satellite access information; deriving a security key for satellite-based access based on the satellite access information, and sending, to the satellite-based access node, a response comprising the security key.

The apparatus may comprise at least one processor and at least one memory storing instructions that, when executed by the at least one processor, cause the apparatus at least to: receive, from a satellite-based access node, a message comprising satellite access information; derive a security key for satellite-based access based on the satellite access information, and send, to the satellite-based access node, a response comprising the security key.

An apparatus may comprise means for: sending, to an access and mobility management function, a message comprising satellite access information; receiving, from the access and mobility management function, a response comprising a security key for satellite-based access, wherein the security key is based at least in part on the satellite access information; and sending, to a user equipment, a security message comprising the satellite access information.

The apparatus may comprise at least one processor and at least one memory storing instructions that, when executed by the at least one processor, cause the apparatus at least to: send, to an access and mobility management function, a message comprising satellite access information; receive, from the access and mobility management function, a response comprising a security key for satellite-based access, wherein the security key is based at least in part on the satellite access information; and send, to a user equipment, a security message comprising the satellite access information.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-13. (canceled)

14. An apparatus comprising:
at least one processor; and
at least one memory storing instructions which, when executed by the at least one processor, cause the apparatus at least to perform:
receiving, from a satellite-based access node, a message comprising satellite access information;
deriving a security key for satellite-based access based at least in part on the satellite access information;
performing a security procedure to protect a message based at least in part on the security key; and
sending the message to the satellite-based access node.

15. An apparatus comprising:
at least one processor; and
at least one memory storing instructions which, when executed by the at least one processor, cause the apparatus at least to perform:
receiving, from a satellite-based access node, a message comprising satellite access information;
deriving a security key for satellite-based access based at least in part on the satellite access information; and
sending, to the satellite-based access node, a response to the message, the response comprising the security key.

16. An apparatus comprising:
at least one processor; and
at least one memory storing instructions which, when executed by the at least one processor, cause the apparatus at least to perform:
sending, to an access and mobility management function, a message comprising satellite access information;
receiving, from the access and mobility management function, a response to the message, the response comprising a security key for satellite-based access, wherein the security key is based at least in part on the satellite access information;
sending, to a user equipment, a security message comprising the satellite access information; and
performing a security procedure based at least in part on the security key received from the access and mobility management function.

17.-19. (canceled)

20. The apparatus of claim 14, wherein the performing the security procedure to protect the message is based at least in part on the security key and at least in part on another security key available at the satellite-based access node.

21. The apparatus of claim 14, wherein the preforming the security procedure to protect the message comprises integrity protecting, encrypting, or both integrity protecting and encrypting the message based at least in part on the security key.

22. The apparatus of claim 15, wherein the satellite access information comprises information indicating that a user equipment access type is satellite-based access, and wherein the deriving the security key is further based at least in part on the information indicating that the user equipment access type is satellite-based access.

23. The apparatus of claim 15, wherein the satellite access information comprises information indicating a type of satellite, and wherein the deriving the security key is further based at least in part on the information indicating the type of satellite.

24. The apparatus of claim 23, wherein the type of satellite is one of: low Earth orbit, medium Earth orbit, geostationary Earth orbit, or other satellite type.

25. The apparatus of claim 15, wherein the satellite access information comprises information identifying a satellite, and wherein the deriving the security key is further based at least in part on the information identifying the satellite.

26. The apparatus of claim 15, wherein the satellite access information comprises information indicating that a target access node type is non-terrestrial, and wherein the deriving the security key is further based at least in part on the information indicating that the target access node type is non-terrestrial.

27. The apparatus of claim 15, wherein deriving the security key is based at least in part on a next hop chaining count value, and wherein the next hop chaining count value is an integer having a maximum value greater than 7.

28. The apparatus of claim 16, wherein the performing the security procedure is further based at least in part on a security key generated by the user equipment based at least in part on the satellite access information.

29. The apparatus of claim 16, wherein the performing the security procedure comprises receiving an access stratum security mode complete message from the user equipment based at least in part on the security key, wherein the access stratum security mode complete message is integrity protected, or encrypted, or integrity protected and encrypted based at least in part on the security key.
